(19) United States
(12) Patent Application Publication
(10) Pub. No.: US 2023/0101199 A1
(43) Pub. Date: Mar. 30, 2023

(54) DRIVE DEVICE FOR A MOTOR VEHICLE DRIVE TRAIN OF AN ELECTRIC VEHICLE

(71) Applicant: ZF Friedrichshafen AG, Friedrichshafen (DE)

(72) Inventors: Tobias Brilka, Iggensbach (DE); Franz Reitinger, Esternberg (DE); Andreas Pfeffer, Viechtach (DE); Alexander Mühlbauer, Windorf (DE)

(73) Assignee: ZF Friedrichshafen AG, Friedrichshafen (DE)

(21) Appl. No.: 17/930,897

(22) Filed: Sep. 9, 2022

(30) Foreign Application Priority Data
Sep. 27, 2021 (DE) 10 2021 210 727.3

(51) Int. Cl. B60K 17/356; B60K 1/02; B60K 17/346

(52) U.S. Cl. CPC B60K 17/356; B60K 1/02; B60K 17/3462; B60Y 2200/20

(57) ABSTRACT

A drive device (7) for a motor vehicle drive train of an electric vehicle has a plurality of electric machines (12, 13, 14) and a transmission, where different transmission ratios between an input shaft and an output side can be selected. In this case, a first electric machine (13) is connected to the input shaft of the transmission or can be connected thereto, and the output side of the transmission is coupled to at least one output drive (9, 10), which is used in the motor vehicle drive train to connect a respective drive axle of the electric vehicle. In order to achieve the highest possible driving comfort by means of this drive device (7), a second electric machine (14) is also permanently connected to the output side.

### RELATED APPLICATIONS

This application claims the benefit of and right of priority under 35 U.S.C. § 119 to German Patent Application no. 10 2021 210 727.3, filed on 27 Sep. 2021, the contents of which are incorporated herein by reference in its entirety.

### FIELD OF THE DISCLOSURE

The invention relates to a drive device for a motor vehicle drive train of an electric vehicle, in particular in the form of an off-road utility vehicle, comprising a plurality of electric machines and a transmission, in which different transmission ratios between an input shaft and an output side can be selected, wherein a first electric machine is connected or can be connected to the input shaft of the transmission, and wherein the output side of the transmission is coupled to at least one output drive, which is used in the motor vehicle drive train to connect a respective drive axle of the electric vehicle. Furthermore, the invention relates to a motor vehicle drive train, an electric vehicle and a method for operating a drive device according to the invention.

### BACKGROUND

In electric vehicles, drive devices are known which frequently comprise at least one electric machine and one or more downstream transmissions. In some cases, different gears can be selected in order to transfer a driving motion of the at least one electric machine using different transmission ratios.

DE 10 2016 006 208 A1 discloses a drive device for a motor vehicle drive train which is designed for an electric vehicle in the form of a utility vehicle. In one variant, this drive device comprises two electric machines, downstream of which is a transmission. In the transmission, different transmission ratios can be selected in order to couple one or both electric machines to an output side of the transmission. Here, the output side is coupled to at least one output drive, to which a respective drive axle of the electric vehicle is connected within the motor vehicle drive train.

### SUMMARY

Proceeding from the prior art described above, it is now the object of the present invention to implement a drive device for an electric vehicle, the intention being that this drive device should be able to achieve a high level of driving comfort.

This object is achieved on the basis of a drive device and a motor vehicle drive train including the drive device, in accordance with embodiments disclosed herein. In another aspect of the present disclosure, an electric vehicle includes the motor vehicle drive train. Further disclosed is a method for operating a drive device according to the invention.

According to the invention, a drive device comprises a plurality of electric machines and a transmission, wherein different transmission ratios between an input shaft and an output side can be selected. In this arrangement, a first electric machine is connected to the input shaft of the transmission or can be connected to said input shaft, while the output side of the transmission is coupled to at least one output drive, which is used in the motor vehicle drive train to connect a respective drive axle of the electric vehicle.

In the drive device according to the invention, therefore, in addition to a plurality of electric machines, a transmission is provided which has an input shaft, it being possible for this input shaft to be coupled to an output side of the transmission in each case by selecting one of a plurality of different transmission ratios. Thus, different force flow routes with transmission ratios that differ from one another can be implemented between the input shaft and the output side of the transmission, this preferably being performed by selective actuation of shift elements.

Within the drive device according to the invention, the output side of the transmission is coupled to at least one output drive, wherein, in the installed state of the drive device, this at least one output drive is provided in a motor vehicle drive train for connection to a respective drive axle of the electric vehicle.

Of the electric machines, a first electric machine is either permanently connected to the input shaft of the transmission or can be connected to the input shaft of the transmission. In the first-mentioned case, there is a constant rotational speed ratio permanently present between the electric machine and the input shaft of the transmission, with the result that the input shaft and a rotor of the first electric machine cannot rotate independently of one another. In contrast, in the second case mentioned, the first electric machine can also be decoupled from the input shaft of the transmission and is connected selectively to the input shaft, this preferably being accomplished, for purposes of the invention, via an intermediate dutch. In this case, this dutch is designed, in particular, as a positive-locking clutch, wherein the positive-locking clutch is designed, in particular, as an unsynchronized claw clutch or as a locking synchromesh. As an alternative to this, however, an intermediate clutch can also be designed as a nonpositive clutch, for example as a friction clutch or multi-disk clutch.

In the context of the invention, the first electric machine can be connected or be connectable directly to a connection point of the input shaft for conjoint rotation therewith if the first electric machine is arranged directly in the region of the connection point of the input shaft. Alternatively, however, an offset arrangement of the first electric machine with respect to a connection point of the input shaft is also possible, in which case a cardan shaft is then preferably provided in between in order to connect or enable the connection of the first electric machine to the input shaft of the transmission for conjoint rotation therewith.

The plurality of electric machines of the drive device according to the invention preferably each consist of a stator and a rotor, More specifically, it is possible, in particular, on the one hand, for each of the electric machines to be operated as a generator, with the individual electric machine generating current in its generator mode. On the other hand, the individual electric machine can also be operated as an electric motor, for which purpose, in the electric motor mode of the individual electric machine, a driving motion of the respective rotor is generated by the power supply.

The invention now includes the technical teaching that a second electric machine is permanently connected to the output side. In other words, in addition to the first electric machine, which is connected to the input shaft or can be connected thereto, a second electric machine is also provided, which is continuously coupled to the output side of the transmission and thus also to the at least one output drive.

Such a configuration of a drive device has the advantage that, as a result of the permanent connection of the second electric machine to the output side of the transmission and thus also to the at least one output drive in the installed state of the drive device according to the invention, a continuous connection to drive wheels of the at least one drive axle of the electric vehicle is thus also produced. Consequently, driving of the electric vehicle without any interruption in the tractive effort can be achieved without problems by means of the second electric machine. In addition, the first electric machine can furthermore be included by selecting in each case one of the transmission ratios of the transmission, it being possible in this case for a driving motion of the first electric machine to be transmitted in a suitable manner via the transmission, depending on requirements. Overall, it is thereby possible to cover a large driving range of the electric vehicle by means of the electric machines and by means of transmission of a driving motion of the first electric machine by the transmission.

In this case, the first electric machine and the second electric machine can be used jointly to drive the electric vehicle by operating both electric machines as electric motors. In this case, depending on the driving range to be formed, a corresponding transmission ratio is selected in the transmission in order to transmit the driving motion generated by the first electric machine in a suitable manner. If a change from one transmission ratio of the transmission to another transmission ratio is then worthwhile or necessary, the tractive effort can still be maintained by means of the second electric machine in the course of the change and the associated separation of the first electric machine from the at least one output drive, which occurs at least for a short time. Thus, a high level of driving comfort can be achieved if the drive device according to the invention is used in a motor vehicle drive train.

In its respective generator mode, the individual electric machine can furthermore be used for braking by energy recovery, it likewise being possible in this case, with regard to the first electric machine, to select a suitable transmission ratio in the transmission in order to generate a high driving speed on the part of the first electric machine. On the other hand, as a result of the permanent coupling to the at least one output drive, braking by operation as a generator can be performed directly by means of the second electric machine.

In contrast, the electric machines in DE 10 2016 006 208 A1 can be used for driving or else braking of the electric vehicle only by selecting one of the transmission ratios in the transmission, since neither of the electric machines is permanently coupled to the at least one output drive of the electric vehicle.

According to one embodiment of the invention, a countershaft, which is permanently coupled to the output side, is provided in the transmission, being axially offset with respect to the input shaft. Moreover, the input shaft and the countershaft can each be coupled to one another via a first spur gear stage and a second spur gear stage, which each consist of a fixed gear and a free gear meshing therewith. In the spur gear stages, the respective fixed gear is arranged for conjoint rotation on the input shaft or the countershaft, while the respective free gear of the respective spur gear stage is mounted rotatably on the countershaft or the input shaft and can be fixed there via a respective associated shift element. In this case, the transmission is thus designed as a two-stage transmission in that two spur gear stages are provided between the input shaft and a countershaft permanently coupled to the output side, via which stages a force flow can be directed from the input shaft to the countershaft and thus to the output side in each case by actuation of an associated shift element. As a particular preference here, one transmission ratio, which can be formed by means of one spur gear stage, is designed as a road gear, while the transmission ratio which is formed when the other spur gear stage is included into the power flow, forms, in particular, an off-road gear for the electric vehicle. Within the scope of the invention, however, the transmission could also have more than two shiftable spur gear stages.

In the case of the individual spur gear stage, in each case one fixed gear and in each case one free gear are provided, which are continuously in mesh with one another. Of these two spur gears, which are preferably each equipped with helical toothing, one is arranged on the input shaft and one on the countershaft. In this case, the fixed gear of the respective spur gear stage is located for conjoint rotation on the respective shaft, while the respective free gear can be mounted rotatably on the respective shaft and can be fixed there by actuating the associated shift element.

As a development of the abovementioned embodiment, at least in one of the two spur gear stages, the respective fixed gear is located for conjoint rotation on the countershaft and the respective free gear is mounted rotatably on the input shaft, wherein the respective fixed gear of this spur gear stage also forms the output side of the transmission in that the coupling with the at least one output drive is produced at this fixed gear. In this way, the fixed gear of this spur gear stage can advantageously be used to produce the output-side coupling of the transmission. For this purpose, on the toothing of this fixed gear, in addition to the meshing with the free clear of the spur gear stage, meshing with further toothing is preferably also produced, at which, in the installed state of the drive device according to the invention, a further force flow route to the at least one output drive and thus also to the respective drive axle can then be implemented. In particular, in the transmission, the fixed gears of both spur gear stages are arranged for conjoint rotation on the countershaft, and the free gears of both spur gear stages are mounted rotatably on the input shaft.

Alternatively or in addition to the abovementioned variant, a first shift element and a second shift element are combined to form a shifting device, via whose actuating element the first shift element can be actuated, on the one hand, and the second shift element can be actuated, on the other hand. As a result, actuation of the two shift elements can be performed by means of a common actuating element, reducing the outlay on production and, in addition, making it possible to have a compact construction. As a particular preference, it is possible here, in addition to a first shift position, in which the first shift element is actuated, and a second shift position, in which the second shift element is actuated, for this actuating element also to be positioned in a neutral position, in which neither the first shift element nor the second shift element is transferred into a closed state. As a result, there is advantageously the possibility of decoupling the first electric machine and, if appropriate, a further electric machine provided here, from the output side of the transmission and thus also from the at least one output drive. In this way, it is possible in certain driving states to prevent the first electric machine and a further, optionally provided, electric machine from being taken along.

Within the scope of the invention, the shift elements of the transmission are preferably designed as positive-locking shift elements, wherein the shift elements are in this case, in particular, in the form of unsynchronized claw shift elements or in the form of locking synchromesh elements. Alternatively, however, embodiment of one or more shift elements as nonpositive shift elements and, in this case, in particular as multi-disk shift elements is also possible.

As a development of the invention, the second electric machine is connected to the countershaft for conjoint rotation therewith. Permanent coupling of the second electric machine to the output side of the transmission and thus to the at least one output drive can thereby be implemented in a reliable manner. In this case, the second electric machine can be connected directly to the countershaft for conjoint rotation therewith in that a rotor of the second electric machine is fastened directly to a connection point of the countershaft—optionally by means of a rotor shaft. As an alternative to this, however, provision can also be made within the scope of the invention for the rotational connection between the second electric machine and the countershaft to be implemented via intermediate components, such as, for example, a cardan shaft.

According to an advantageous embodiment of the invention, the second electric machine is the most powerful electric machine of the electric machines. This has the advantage that during operation of the drive device according to the invention in a motor vehicle drive train, driving of the electric vehicle can be maintained even when a change between transmission ratios is just taking place in the transmission and, accordingly, the first electric machine is separated from the at least one output drive. In this case, a drive power which can be provided by means of the second electric machine should be selected in such a way that the electric vehicle can be driven adequately by a single machine, at least for a short time.

According to one embodiment of the invention, in addition to the first electric machine and the second electric machine, at least one further electric machine is provided, which is in each case connected to the input shaft or can be connected to the input shaft via an intermediate clutch. As a result, the overall drive power which can be provided can be increased further, it being possible, if appropriate, for the at least one electric machine to be connected via an intermediate dutch only in special situations in which a particularly high drive power must be available. In this case, the at least one further electric machine can be fastened directly to a connection point of the input shaft or can be connectable to this connection point via the intermediate dutch, it also being possible, however, as an alternative to this, for intermediate components, such as, for example, a cardan shaft, to be provided.

According to one possible configuration of the invention, the transmission is followed on the output side by a distributor device, the drive side of which is coupled to the output side and to which a plurality of output drives is assigned, which are each used in the motor vehicle drive train to connect a respective drive axle of the electric vehicle. As a result, the drive device can be used in an electric vehicle with all-wheel drive or selectable all-wheel drive in that distribution to a plurality of output drives and thus, in the installed state, to a plurality of drive axles can be performed by means of the downstream distributor device.

As a development of the abovementioned possible configuration, the distributor device comprises a differential, which is configured, in particular, as a planetary differential. A drive power introduced at the drive side of the distributor device can be distributed via the differential to output shafts, which are each connected to one of the output drives. As a particular preference, a locking device is furthermore assigned to the differential, and when this locking device is actuated, rigid distribution to the output drives is performed. As an alternative to embodiment as a planetary differential, however, the differential can also be embodied as a bevel gear differential. Moreover, it is also possible in principle, within the scope of the invention, to consider an embodiment of the distributor device in which only one of the output drives is permanently coupled to the output side of the transmission, while one or more further output drives can be coupled to the drive side of the distributor device only by actuation of a respectively associated clutch.

The invention furthermore relates to a motor vehicle drive train for an electric vehicle, wherein a drive device according to one or more of the abovementioned variants is provided in this motor vehicle drive train. When the drive device is embodied with a distributor device, at least one drivable front axle is then preferably operatively connected to one output drive and at least one drivable rear axle is operatively connected to another output drive. Overall, it is thereby possible to obtain a motor vehicle drive train in which, as a result of the permanent coupling of the second electric machine to the output drive or the output drives, operation without interruption of the tractive effort and thus also a high level of comfort can be provided.

The invention furthermore relates to an electric vehicle which is equipped with an abovementioned motor vehicle drive train. This electric vehicle may be, in particular, an off-road utility vehicle, such as a truck.

The invention also relates to a method for operating a drive device according to the invention. In this case, changes between transmission ratios of the transmission are carried out in that, in the course of the respective change, a loss of in each case one drive torque of at least the first electric machine is compensated for at least as far as possible by increasing a drive torque of the second electric machine. Thus, if changes are made between transmission ratios in the transmission, resulting in temporary decoupling of the first electric machine and, where applicable, also of at least one further electric machine due to an interruption in the tractive effort, an attempt is made to compensate for a loss of a drive torque of the first electric machine and, where applicable, of the at least one further electric machine by means of the second electric machine by increasing its drive torque.

As a development of the abovementioned method, synchronization of rotational speeds is performed at least via the first electric machine in the course of the respective change. Within the scope of the invention, this is achieved, in particular, if shift elements via which changes between the transmission ratios are carried out are embodied as positive-locking and, in this case, in particular, as unsynchronized shift elements. In this case, rapid shifting between the transmission ratios can be provided by synchronization via the first electric machines and, where applicable, the at least one further electric machine.

The invention is not restricted to the specified combination of the features recited in the independent claim or of the claims dependent thereon. There are in addition possibilities for combining individual features with one another, including insofar as they emerge from the claims, the following description of preferred embodiments of the invention or directly from the drawings. The references in the claims to the drawings by the use of reference signs are not intended to restrict the scope of protection of the claims.

### BRIEF DESCRIPTIONS OF THE DRAWINGS

Advantageous embodiments of the invention, which will be explained below, are illustrated in the drawings. In the drawings:

FIG. 1 shows a schematic illustration of an electric vehicle according to a preferred embodiment of the invention;

FIG. 2 shows a schematic illustration of a drive device of the electric vehicle from FIG. 1, corresponding to a first possible configuration of the invention;

FIG. 3 shows a schematic individual view of a part of the drive device from FIG. 2;

FIG. 4 shows diagrams with various parameter curves in the course of a change of a transmission ratio in a transmission of the drive device from FIGS. 2 and 3; and

FIGS. 5 and 6 show schematic views of drive devices according to further embodiments of the invention.

### DETAILED DESCRIPTION

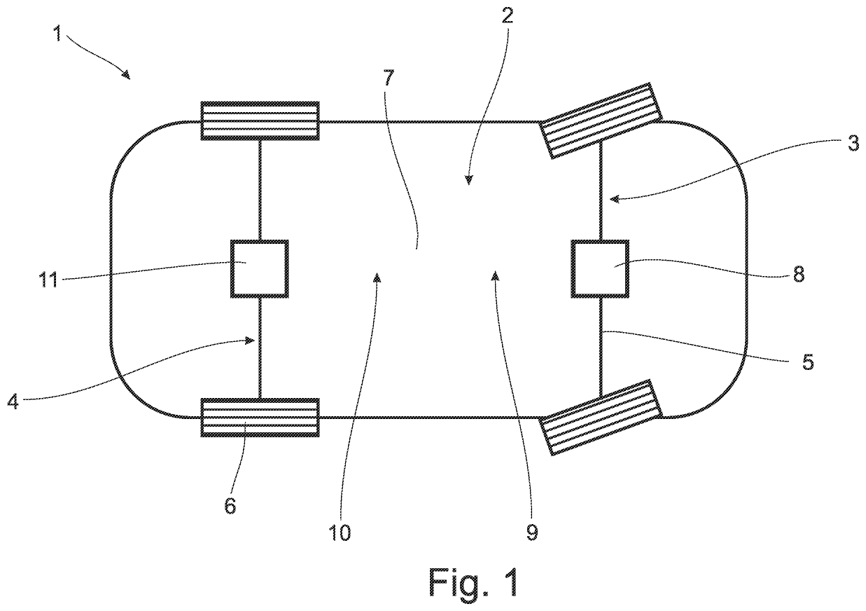

FIG. 1 shows a schematic view of an electric vehicle 1, which is, in particular, an off-road utility vehicle and, in this case, is preferably a truck. In this case, the electric vehicle 1 has a motor vehicle drive train 2, which is equipped with two drive axles 3 and 4. In this arrangement, drive axle 3 is a steerable front axle 5 and drive axle 4 is a nonsteerable rear axle 6. In this respect, the electric vehicle 1 is equipped with permanent all-wheel drive.

Within the motor vehicle drive train 2, the two drive axles 3 and 4 can be driven by means of a drive device 7, which is placed between the drive axles 3 and 4 in the longitudinal direction of the electric vehicle 1. Specifically, an axle differential 8 of drive axle 3 is here connected to an output drive 9 of the drive device 7, wherein the drive device 7 is furthermore connected at an output drive 10 to an axle differential 11 of drive axle 4.

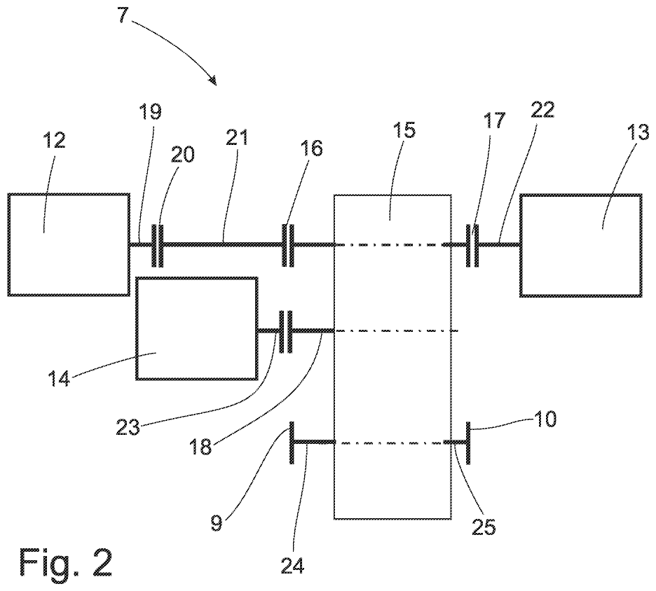

FIG. 2 shows a schematic individual view of the drive device 7, which is designed according to a first embodiment of the invention. This drive device 7 comprises three electric machines 12, 13 and 14, each of which consists of a rotor and a stator (although this is not illustrated here). In addition, it is possible for each of the electric machines 12 to 14 to be operated, on the one hand, as a generator and, on the other hand, as an electric motor. Moreover, the drive device 7 is equipped with a transmission unit 15, which is illustrated only schematically in FIG. 2. The transmission unit 15 is equipped with a plurality of connection points 16, 17 and 18, to which in each case one of the electric machines 12 to 14 is connected for conjoint rotation therewith. In this case, connection points 16 and 17 are coaxial with respect to one another, while connection point 18 is placed axially offset with respect to the two connection points 16 and 17.

In the present case, electric machine 12 is connected to connection point 16 for conjoint rotation therewith in that a rotor shaft 19 produces a rotational connection between the rotor of electric machine 12 and a connection point 20, at which the rotor shaft 19 and thus also the rotor of electric machine 12 are connected to a cardan shaft 21 for conjoint rotation therewith. Via the cardan shaft 21, the rotor shaft 19 is indirectly connected to connection point 16 of the transmission unit 15, for which purpose the cardan shaft 21 is fastened to connection point 16 at the end opposite to the rotor shaft 19. In this case, electric machine 12 is placed coaxially with connection point 16 of the transmission unit 15, but it could also be offset with respect to connection point 16 by means of the cardan shaft 21.

As can furthermore be seen in FIG. 2, electric machine 13 is connected to connection point 17 for conjoint rotation therewith by means of a rotor shaft 22, wherein here the rotor shaft 22 is connected to the rotor of electric machine 13 for conjoint rotation therewith within electric machine 13. In this case, electric machine 13 with the rotor shaft 22 is arranged coaxially with connection point 17.

In the case of electric machine 14, a rotor shaft 23 is connected to the rotor of electric machine 14 for conjoint rotation therewith, wherein the rotor shaft 23 is furthermore fastened to connection point 18 of the transmission unit 15 for conjoint rotation therewith by means of one shaft end. In the present case, electric machine 14 and thus also the rotor shaft 23 are arranged coaxially with connection point 18 of the transmission unit 15.

The transmission unit 15 is equipped with two output shafts 24 and 25, which are coaxial with one another and are axially offset with respect to the connection points 16 to 18. In this case, at mutually remote shaft ends, these output shafts 24 and 25 form the two output drives 9 and 10, at which the connection to the respectively associated drive axle 3 and 4 is in each case established within the motor vehicle drive train 2 of the electric vehicle 1, which can be seen in FIG. 1.

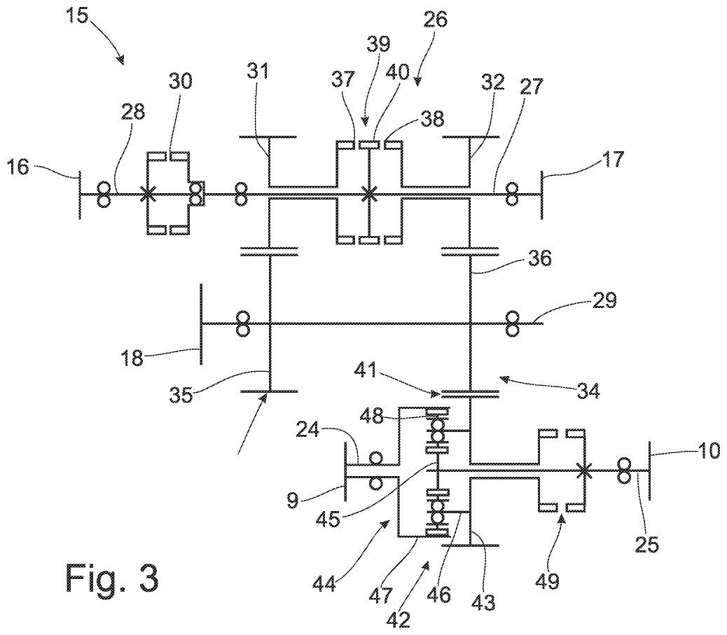

In FIG. 3, the transmission unit 15 is furthermore illustrated individually in a schematic way. As can be seen here, the transmission unit 15 comprises a transmission 26, in which, in addition to an input shaft 27, a connecting shaft 28 and a countershaft 29 are also provided. In this case, the connecting shaft 28 forms connection point 16 at one shaft end and can be connected to the input shaft 27, which is located coaxially with respect to it, for conjoint rotation therewith via an intermediate clutch 30. In this case, the clutch 30 is designed as a positive-locking clutch in the form of an unsynchronized claw clutch.

At an end located axially remote from the connecting shaft 28, the input shaft 27 forms connection point 17, wherein, in addition, two free gears 31 and 32, each of which is part of a spur gear stage 33 and 34, respectively, are rotatably supported on the input shaft 27. In this case, free gear 31 in spur gear stage 33 is permanently in mesh with a fixed gear 35, which is arranged for conjoint rotation on the countershaft 29. In this arrangement, the countershaft 29 is placed axially offset with respect to the input shaft 27 and also the connecting shaft 28 and forms connection point 18 at one shaft end. In addition to fixed gear 35, a fixed gear 36 of spur gear stage 34 is also arranged for conjoint rotation on the countershaft 29, wherein fixed gear 36 is in constant mesh with free gear 32 within spur gear stage 34.

In the transmission 26, two different transmission ratios can now be selected, in that, starting from the input shaft 27, a power flow is directed to the countershaft 29 either via spur gear stage 33 or via spur gear stage 34. For this purpose, the transmission 26 is equipped with two shift elements 37 and 38, of which shift element 37, when actuated, fixes free gear 31 to the input shaft 27 and accordingly effects guidance of the force flow from the input shaft 27 to the countershaft 29 via spur gear stage 33. On the other hand, shift element 38, when actuated, fixes free gear 32 to the input shaft 27 and accordingly ensures coupling of the input shaft 27 and the countershaft 29 via spur gear stage 34.

In the present case, the shift elements 37 and 38 are designed as positive-locking shift elements, wherein they are in the form of unsynchronized claw shift elements. In this case, the two shift elements 37 and 38 are combined to form a shifting device 39, to which an actuating element 40 is assigned, it being possible, by means of the actuating element 40, for shift element 37, on the one hand, and shift element 38, on the other hand, to be transferred from a neutral position to a respectively actuated state. In contrast, in the neutral position of the actuating element 40, which is preferably a sliding sleeve, neither of the shift elements 37 and 38 is actuated, as a result of which neither of the free gears 31 and 32 is fixed and, accordingly, the input shaft 27 is decoupled from the countershaft 29.

The fixed gear 36 of spur clear stage 34 also forms an output side 41 of the transmission 26, in that a connection to a distributor device 42 is established permanently at the fixed gear 36. In this case, this distributor device 42 is connected downstream of the transmission 26 within the transmission unit 15 and has a spur gear 43 which is in permanent mesh with fixed gear 36. The distributor device 42 furthermore has a differential 44, which is designed as a planetary differential in the present case and consists of a sun gear 45, a planet carrier 46 and a ring gear 47. In this case, a plurality of planet gears 48 is mounted rotatably in the planet carrier 46, and, more specifically, each is in mesh with both the sun gear 45 and the ring gear 47.

While, in the present case, the planet carrier 46 is connected to the spur gear 43 for conjoint rotation therewith, the sun gear 45 is connected to the output shaft 25 for conjoint rotation therewith, and the ring gear 47 is connected to the output shaft 24 for conjoint rotation therewith. In this case, a drive power introduced via the output side 41 of the transmission 26 is distributed to the two output shafts 24 and 25 via the differential 44, it being possible here for different rotational speeds of the output shafts 24 and 25 to be permitted by means of the differential 44. In this case, however, this effect of the differential 44 can be selectively blocked by way of a locking device 49, which is designed as a clutch and, when actuated, connects the spur gear 43 to the output shaft 25 for conjoint rotation therewith, resulting in locking up of the planetary differential.

Owing to the connection of electric machine 14 to connection point 18 of the transmission unit 15 for conjoint rotation therewith and the permanent coupling of the countershaft 29 to the output drives 9 and 10 via the distributor device 42, electric machine 14 is also permanently coupled to the output drives 9 and 10. Accordingly, electric machine 14 can be used continuously for driving the electric vehicle 1 in its electric motor mode or else for braking the electric vehicle in its generator mode. In this case, electric machine 14 of the electric machines 12 to 14 is embodied as the most powerful machine.

In contrast, the electric machine 13 connected to connection point 17 is coupled to the output drives 9 and 10 only when one of the shift elements 37 and 38 is actuated and, accordingly, one of the two transmission ratios of the transmission 26 is selected. The same is also the case with respect to electric machine 12, in which case clutch 30 has to be actuated in addition. Via the transmission ratios of the transmission 26, driving movements of one or both electric machines 12 and 13 can in this case be transmitted to the countershaft 29 in their respective electric motor mode, or else their respective braking action can be modified in their respective generator mode. As regards the transmission 26, one transmission ratio is here designed as a road gear, while the other transmission ratio is designed as an off-road gear.

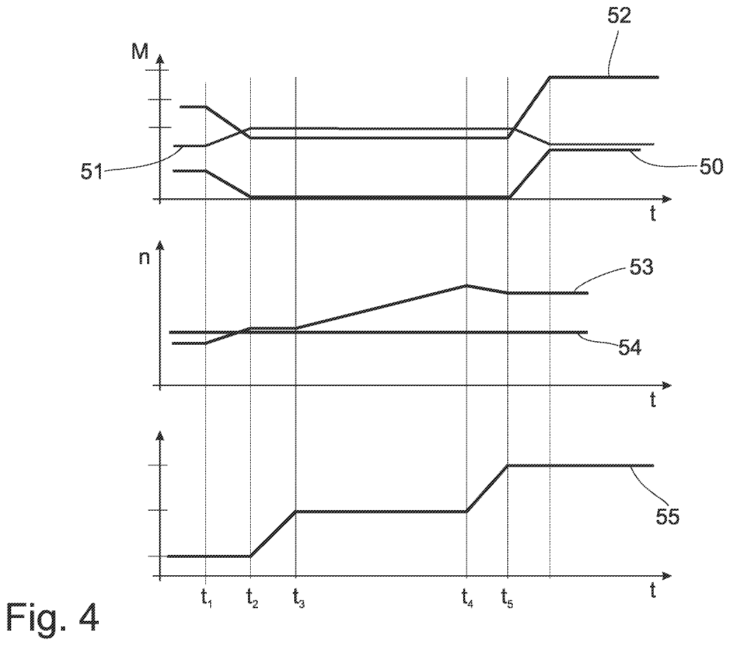

FIG. 4 illustrates, by way of example, flow diagrams of various parameters in the course of a change between the transmission ratios of the transmission 26, this being shown for carrying out a downshift in the transmission 26 and for a state of the drive device 7 in which electric machine 12 is decoupled by means of clutch 30. In the uppermost diagram, drive torques M are here plotted against time t, a line 50 here representing a drive torque of electric machine 13, a line 51 representing a drive torque of electric machine 14, and a line 52 representing a sum of the drive torques of electric machines 13 and 14.

In contrast, it is rotational speeds n which are plotted against time tin the central diagram, line 53 of lines 53 and 54 here representing the rotational speed curve of electric machine 13 in the course of the change, while line 54 reproduces the rotational speed curve of electric machine 14. Finally, in the lowermost diagram, a shift position of the actuating element 40 is plotted against time t and is reproduced by means of line 55.

As can be seen from the diagrams in FIG. 4, at the beginning of the change, the actuating element 40 is in one of its shift positions, in which one transmission ratio is selected in the transmission 26, Δt a first time t₁, there is then a request to change the transmission ratio in the transmission 26, whereupon the drive torque in electric machine 13 is reduced and the rotational speed is increased to a target rotational speed in order to be able to set synchronous rotational speeds with respect to the respective shift element 37 or 38 that is being actuated and is subsequently to be opened and to be able to design this without problems. At the same time, a drive torque of electric machine 14 is increased in order to keep the reduction of the sum of the drive torques as small as possible and thus to make the effect of the gear change as little noticeable as possible.

At a time t₂, synchronous rotational speeds have then been established at the shift element 37 or 38 to be opened, whereupon the actuating element 40 is moved in the direction of its neutral position. In this case, drive torques of the two electric machines 13 and 14 are kept constant from this point in time. From a point in time t₃, the actuating element 40 is then moved into its neutral position and, accordingly, the input shaft 27 and thus also the electric machine 13 coupled thereto are decoupled from the countershaft 29. As soon as the neutral position is reached, a rotational speed of electric machine 13 is increased in order to set synchronous rotational speeds at the shift element 38 or 37 which is subsequently to be actuated.

In this case, these synchronous rotational speeds are reached at a time t₄, whereupon the actuating element 40 is now moved out of the neutral position in the direction of the shift position in which the shift element 38 or 37 is actuated. Here, this process is completed at a point in time t₅, with the result that the transmission ratio in the transmission 26 is now selected. From time t₅, the drive torque of drive machine 13 is now also increased again, as a result of which the sum of the drive torques is correspondingly increased as well. In this case, a driving motion of electric machine 13 is now transmitted with the selected transmission ratio via the transmission 26.

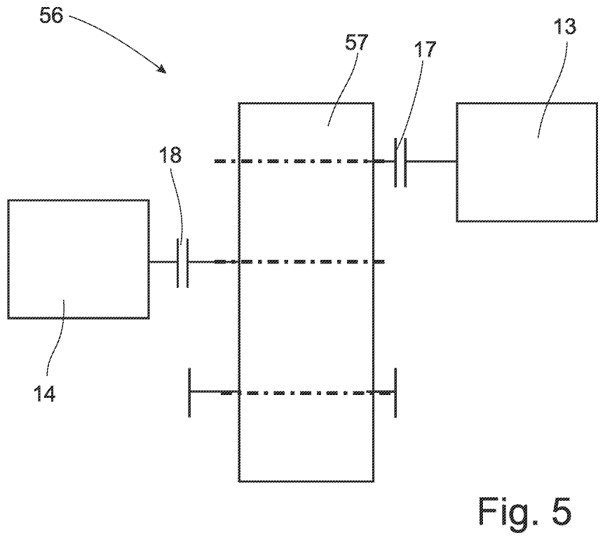

Furthermore, FIG. 5 shows a schematic view of a drive device 56 which is designed according to a second possible embodiment of the invention and can likewise be used in the electric vehicle 1 from FIG. 1, In this case, this possible configuration corresponds substantially to the variant according to FIGS. 2 to 4, with the difference that now only electric machines 13 and 14 are provided. Because of this reduced number of electric machines, a transmission unit 57 of a drive device 56 is also equipped only with connection points 17 and 18. Furthermore, it is preferable if no clutch is provided within the transmission unit 57 either. In other respects, the possible configuration according to FIG. 5 corresponds to the variant according to FIGS. 2 to 4, and therefore attention is drawn to what is described in relation thereto.

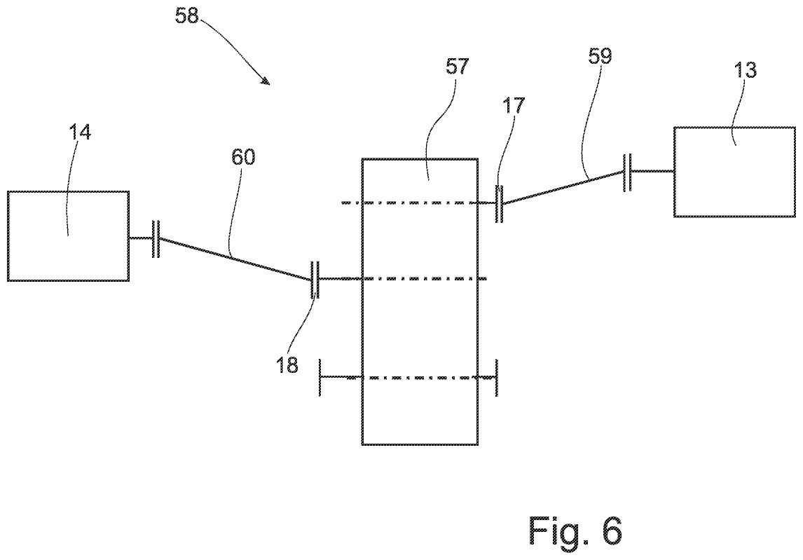

Finally, FIG. 6 shows a schematic illustration of a drive device 58, which is embodied according to a third embodiment of the invention and can be used in the electric vehicle 1 from FIG. 1. Here, this embodiment corresponds substantially to the preceding variant according to FIG. 5, although, in contrast to this, electric machine 13 and electric machine 14 are now not connected directly to the respective connection point 17 or 18 but are fastened via interposed cardan shafts 59 and 60. As a result, electric machines 13 and 14 can also be placed with an offset with respect to the respective connection point 17 or 18. In other respects, the possible configuration according to FIG. 6 corresponds to the variant according to FIG. 5, and therefore attention is drawn to what is described in relation thereto.

It is possible to achieve a high level of driving comfort in an electric vehicle by means of the embodiments of a drive device according to the invention.

### REFERENCE SIGNS

1 electric vehicle
2 motor vehicle drive train
3 drive axle
4 drive axle
5 front axle
6 rear axle
7 drive device
8 axle differential
9 output drive
10 output drive
11 axle differential
12 electric machine
13 electric machine
14 electric machine
15 transmission unit
16 connection point
17 connection point
18 connection point
19 rotor shaft
20 connection point
21 cardan shaft
22 rotor shaft
23 rotor shaft
24 output shaft
25 output shaft
26 transmission
27 input shaft
28 connecting shaft
29 countershaft
30 clutch
31 free gear
32 free gear
33 spur gear stage
34 spur gear stage
35 fixed gear
36 fixed gear
37 shift element
38 shift element
39 shifting device
40 actuating element
41 output side
42 distributor device
43 spur gear
44 differential
45 sun gear
46 planet carrier
47 ring gear
48 planet gears
49 locking device
50 line
51 line
52 line
53 line
54 line
55 line
56 drive device
57 transmission unit
58 drive device
59 cardan shaft
60 cardan shaft
drive torque
n speed
t time
t₁ to t₅ times

1. A drive device (7; 56; 58) for a motor vehicle drive train (2) of an electric vehicle (1), the drive device comprising a plurality of electric machines (12, 13, 14; 13, 14) and a transmission (26) having an input shaft (27) and an output side (41), wherein a plurality of transmission ratios between the input shaft (27) and the output side (41) can be selected, wherein the plurality of electric machines includes a first electric machine (13) connected or configured to be connected to the input shaft (27) of the transmission (26), wherein the output side (41) of the transmission (26) is coupled to at least one output drive (9, 10) of the motor vehicle drive train (2), the at least one output drive connecting the vehicle drive train to a respective drive axle (3, 4) of the electric vehicle (1), and wherein the plurality of electric machines includes a second electric machine (14) permanently connected to the output side (41).

2. The drive device (7; 56; 58) as claimed in claim 1, further comprising a countershaft (29) permanently coupled to the output side (41), the countershaft being axially offset with respect to the input shaft (27), wherein the input shaft (27) and the countershaft (29) can each be coupled to one another via a first spur gear stage (33) and a second spur gear stage (34) each having a fixed gear (35, 36) and a free gear (31, 32) meshing with the fixed gear, wherein in the first spur gear stage (33) and the second spur gear stage (34) the respective fixed gear (35, 36) is arranged for conjoint rotation on the input shaft or the countershaft (29), while the respective free gear (31, 32) of the respective first spur gear stage (33 or the second spur gear stage (34) is mounted rotatably on the countershaft or the input shaft (27) and can be fixed there via a respective associated shift element (37, 38).

3. The drive device (7; 56; 58) as claimed in claim 2, wherein, at least in one of the first spur gear stage (33) or the second spur gear stage (34), the respective fixed gear (35, 36) is located for conjoint rotation on the countershaft (29) and the respective free gear (31, 32) is mounted rotatably on the input shaft (27), wherein the respective fixed gear (36) also forms the output side (41) of the transmission (26) in that the respective fixed gear (36) couples the input shaft to the countershaft of the at least one output drive (9, 10).

4. The drive device (7; 56; 58) as claimed in claim 2 further comprising a first shift element (37) and a second shift element (38), the first shift element and the second shift element in combination form a shifting device (39) having an actuating element (40) configured in a first position to actuate the first shift element (37) and configured in a second position to actuate the second shift element (38).

5. The drive device (7; 56; 58) as claimed in claim 2, wherein the second electric machine (14) is connected to the countershaft (29) for conjoint rotation therewith.

6. The drive device (7; 56; 58) as claimed in claim 1, wherein the second electric machine (14) is a most powerful electric machine of the plurality of electric machines (12, 13, 14; 13, 14).

7. The drive device (7) as claimed in claim 1, further comprising an intermediate clutch (30), wherein, in addition to the first electric machine (13) and the second electric machine (14), the plurality of electric machines includes at least one further electric machine (12), each at least one further electric machine connected to the input shaft or configured to be connected to the input shaft (27) via the intermediate clutch (30).

8. The drive device (7; 56; 58) as claimed in claim 1, wherein the transmission (26) is followed on the output side (41) by a distributor device (42), a drive side of the distributor device being coupled to the output side (41) and to which a plurality of output drives (9, 10) is assigned, each of the plurality of output drives (9, 10) connecting the drive train to a respective drive axle (2, 3) of the electric vehicle (1).

9. The drive device (7; 56; 58) as claimed in claim 8, wherein the distributor device (42) comprises a differential (44), in particular a planetary differential, wherein a drive power introduced at the drive side of the distributor device (42) can be distributed via the differential (44) to output shafts (24, 25), which are each connected to one of the output drives (9, 10).

10. A motor vehicle drive train (2) for an electric vehicle (1), comprising a drive device (7; 56; 58) as claimed in claim 1.

11. The motor vehicle drive train (2) as claimed in claim 10, wherein the transmission (26) is followed on the output side (41) by a distributor device (42), a drive side of the distributor device being coupled to the output side (41) and to which a plurality of output drives (9, 10) is assigned, each of the plurality of output drives (9, 10) connecting the drive train to a respective drive axle (2, 3) of the electric vehicle (1); wherein at least one drivable front axle (5) is operatively connected to one output drive (9) of the plurality of output drives of the drive device (7; 56; 58) and at least one drivable rear axle (6) is operatively connected to another output drive (10) of the plurality of output drives of the drive device (7; 56; 58).

12. An electric vehicle (1), comprising a motor vehicle drive train as claimed in claim 10.

13. A method for operating a drive device (7; 56; 58) as claimed in claim 1, wherein changes between the plurality of transmission ratios of the transmission (26) are carried out in that, in the course of a respective change, a loss of drive torque of at least the first electric machine (13) is compensated for at least in part by increasing a drive torque of the second electric machine (14).

14. The method as claimed in claim 13, further comprising synchronizing rotational speeds at least via the first electric machine (13) in the course of the respective change.

15. The motor vehicle drive train of claim 10, wherein the electric vehicle is configured as an off-road utility vehicle.

16. The electric vehicle of claim 12, wherein the electric vehicle is configured as an off-road utility vehicle.
